(19) United States
(12) Patent Application Publication
(10) Pub. No.: US 2011/0181752 A1
(43) Pub. Date: Jul. 28, 2011

(54) IMAGING ELEMENT AND IMAGING DEVICE

(75) Inventor: Toshiyuki NAKASHIMA, Hyogo (JP)

(73) Assignee: PANASONIC CORPORATION, Osaka (JP)

(21) Appl. No.: 13/082,054

(22) Filed: Apr. 7, 2011

Related U.S. Application Data
(63) Continuation of application No. PCT/JP2009/003975, filed on Aug. 20, 2009.

(30) Foreign Application Priority Data
Oct. 14, 2008 (JP) 2008-265145

(51) Int. Cl. H04N 9/73; H04N 5/335

(52) U.S. Cl. 348/223.1; 348/294; 348/E09.051; 348/E05.091

(57) ABSTRACT

A signal processing portion is adapted to perform first signal processing appropriate for extracting luminance components and color components from first picture signals mainly containing signal components corresponding to the visible-light region, and second signal processing appropriate for extracting luminance components and color components from second picture signals mainly containing signal components corresponding to the near-infrared region, by changing over therebetween, when extracting luminance components and color components from picture signals which an imaging element outputs, in response to reception light.

### TECHNICAL FIELD

The present invention relates to imaging devices which perform signal processing on picture data with inputs of imaging signals from image sensors and the like and, further, output picture data to an external monitor and the like.

### BACKGROUND ART

Japanese Patent Application No. 2008-265145 filed on Oct. 14, 2008 including a specification, drawings and claims is all incorporated herein by reference into the specification of the present application.

In-vehicle cameras and monitoring cameras have been increasingly required to perform photographing even under photographing conditions in locations with no sunlight and no illumination such as during nighttime. In general, in cases of photographing during nighttime, light emitted from an illumination such as a near-infrared light LED is captured by an image sensor sensitive to near-infrared light, but such an image sensor sensitive to near-infrared light also has sensitivity to near-infrared light during daytime, similarly, which makes it impossible to realize preferable color reproduction.

To cope therewith, conventionally, solid imaging device with structures as illustrated in FIG. 9 have been utilized, in order to perform photographing during both daytime and nighttime with a single image sensor as in Patent Document 1. Such a solid imaging device includes an image sensor (an imaging element) 902 which is an image sensor sensitive to both visible light and near-infrared light. During daytime, a near-infrared light cutting filter 901 adapted to pass no light with near-infrared wavelengths therethrough is placed in front of the image sensor 902, in order to cause only visible light to enter the image sensor 902 for enabling more preferable color reproduction processing. On the other hand, during nighttime, the near-infrared light cutting filter 901 is mechanically removed therefrom, in order to allow near-infrared light emitted from a near-infrared illumination to enter the image sensor 902, thereby enabling photographing even during nighttime.

Further, in Patent Document 2, as illustrated in FIG. 10, pixels 1001 to 1004 are placed, wherein these pixels 1001 to 1004 have color filters (filters (red), filters (green), filters (blue) and filters (near-infrared light)) for passing respective wavelengths therethrough, such that these color filters are placed on a solid imaging element. Further, during daytime, image information is calculated from the red, blue and green pixels 1001, 1002 and 1003, while, during nighttime, image information is calculated from the near-infrared light pixels 1004, in order to enable photographing during both daytime and nighttime with the single solid imaging element.

### Prior Art Documents

### Patent Documents

Patent Document 1: JP-A No. 2000-59798

Patent Document 2: JP-A No. 10-065135

### DISCLOSURE OF INVENTION

### Problems to be Solved by the Invention

The conventional example illustrated in FIG. 9 necessitates a mechanism for mechanically opening and closing the near-infrared light cutting filter 901, thereby increasing the cost by an amount corresponding thereto. Furthermore, color components can be extracted during daytithe, but, during nighttime, only near-infrared light is utilized, which makes it impossible to extract color components, thereby making it impossible to capture color images. This degrades the viewability for the person who uses the camera. Further, in cases of apparatuses required to have higher reliability, such as in-vehicle cameras, the quality thereof is degraded by an amount corresponding to the device for opening/closing the near-infrared light cutting filter 901.

With the conventional example illustrated in FIG. 10, during nighttime, image processing is performed only with near-infrared light 1004, which makes it impossible to extract color components, thereby making it impossible to perform color photographing. This degrades the viewability for the person who uses the camera.

It is an object of the present invention to enable capturing color images with a single image sensor both in environments having visible light, such as during daytime, and in environments hardly having visible light, such as during nighttime, in order to improve the viewability for persons who use cameras with lower costs.

### Means for Solving the Problems

An imaging device of the present invention includes: an imaging element; and a signal processing portion adapted to extract a luminance component and a color component from a picture signal outputted from the imaging element, in response to reception light; wherein the picture signal is changed to a first picture signal mainly containing a signal component corresponding to the visible-light region, and a second picture signal mainly containing a signal component corresponding to the near-infrared region, according to the state of the reception light, and the signal processing portion is adapted to perform first signal processing appropriate for extracting the luminance component and the color component from the first picture signal, and second signal processing appropriate for extracting the luminance component and the color component from the second picture signal, by changing over therebetween.

With the imaging element and the imaging device according to the present invention, it is possible to optimally acquire pixel data (luminance components and color components) containing key light in the visible-light region, and pixel data containing key light in the near-infrared light region. This enables capturing color images, regardless of whether the amount of light in the visible-light region is significantly large (such as photographing during daytime) or is insufficient (such as photographing during nighttime). As a result thereof, it is possible to improve the viewability of images.

In the aspect of present invention, the imaging element receiving first light containing a sufficient amount of light in the visible-light region is adapted to output the first picture signal, and the imaging element receiving second light which does not contain a sufficient amount of light in the visible-light region is adapted to output the second picture signal.

In the aspect of the present invention, the signal processing portion is adapted to perform noise reduction processing using an in-frame noise reduction filter on the extracted color component, in the second signal processing.

In the aspect of the present invention, the signal processing portion is adapted to perform noise reduction processing through frame-to-frame additional averaging processing on the extracted color component, in the second signal processing.

In the present invention, there is an aspect where the signal processing portion is adapted to perform, in the second signal processing, correction of motions between frames, on the first signal components, and, thereafter, perform noise reduction processing through the frame-to-frame additional averaging processing on the first signal components which have been subjected to the motion correction.

In the aspect of the present invention, the imaging element includes a first pixel having sensitivity to both the visible-light region and the near-infrared region, and a second pixel selectively having sensitivity to the near-infrared region, the picture signal contains a first signal component outputted from the first pixel and a second signal component outputted from the second pixel, the signal processing portion is adapted to determine that the reception light is the first light and to perform the first signal processing, when the signal level of the first signal component is larger than the signal level of the second signal component and, also, the difference therebetween is equal to or more than a first threshold value, and the signal processing portion is adapted to determine that the reception light is the second light and to perform the second signal processing, when the signal level of the first signal component is larger than the signal level of the second signal component but the difference therebetween is less than the first threshold value, or when the signal level of the first signal component is equal to the signal level of the second signal component.

In the aspect of the present invention, when there is an amount of motion change between frames which is larger than a predetermined amount in the first signal component, the signal processing portion is adapted to perform noise reduction processing through the frame-to-frame additional averaging processing on the color component, without performing correction of the motion between the frames.

In the aspect of the present invention, the signal processing portion is adapted to extract, in the second signal processing, the color component from the first signal component, according to the luminance component extracted through the second signal processing, when the color component can not be accurately extracted from the first signal component.

According to these aspects, it is possible to suppress the influence of noises in creating color components, under conditions where the amount of light in the visible-light region is smaller than the amount of light in the near-infrared light region (such as photographing during nighttime). This enables capturing color images with higher viewability.

Further, in the aspect of the present invention, the second signal processing includes second-1 signal processing for extracting the luminance component and the color component from the first signal component and for performing noise reduction processing using an in-frame noise reduction filter on the extracted color component, and second-2 signal processing for extracting the luminance component and the color component from the first signal component and for performing noise reduction processing through frame-to-frame additional averaging processing on the extracted color component, and the signal processing portion is adapted to perform the first signal processing, the second-1 signal processing and the second-2 signal processing, by changing over thereamong.

Further, in this aspect, the signal processing portion is adapted to perform the second-1 signal processing, when the signal level of the first signal component is larger than the signal level of the second signal component and, also, the difference therebetween is equal to or more than a second threshold value but is less than the first threshold value (the first threshold value>the second threshold value), and the signal processing portion is adapted to perform the second-2 signal processing, when the signal level of the first signal component is larger than the signal level of the second signal component but the difference therebetween is less than the second threshold value, or when the signal level of the first signal component is equal to the signal level of the second signal component.

In the aspect of the present invention, the signal processing portion is adapted to determine the signal levels of the first and second signal components, based on average values of the signal levels of the first and second signal components over the entire screen or average values of the signal levels of the first and second signal components over an arbitrary area within the screen.

According to these aspects, it is possible to change over the signal processing by the signal processing portion, based on the comparison between the signal levels of the first and second signal components, which enables the user to perform imaging in optimum imaging modes, without manually changing over the signal processing. This improves the usability for the user.

In the aspect of the present invention, the signal processing portion is adapted to store, in the storage device, the color component extracted through the first signal processing, and the signal processing portion is adapted to extract the luminance component from the first signal component and, also, is adapted to read the color component stored in the storage device and use the read color component as a color component for an area within which no motion has occurred within frames in the first picture signal and to extract the color component from the first signal component having been subjected to noise reduction processing, for an area within which a motion has occurred within frames, in the second signal processing.

According to this aspect, there is no need for performing noise reduction processing on areas within which no motion has occurred within the frames in the first picture signals, which can eliminate the noise reduction processing for such areas, thereby enabling extraction of more accurate color components. This improves the viewability of images.

The imaging device according to the present invention employs, as an imaging element, an image sensor (imaging element) which includes pixels (first pixels) provided with color filters (blue, green and red, for example) for passing, therethrough, wavelengths in the visible light region and wavelengths in the near-infrared light region and, further, includes pixels (second pixels) provided with color filters for passing, therethrough, only wavelengths in the near-infrared light region, such that the first and second pixels are mixed with each other. Using the image sensor, the imaging device according to the present invention is adapted to extract luminance components and color components from picture signals (first picture signals) corresponding to the visible-light region during daytime. Further, the imaging device according to the present invention is adapted to extract luminance components from first picture signals and picture signals (second picture signals) corresponding to the near-infrared light region and, further, is adapted to apply a noise reduction filter to the first picture signals within the frames or apply additional averaging over the frames for increasing the pixel levels of the first picture signals in the visible light region and, thereafter, calculate color components based on the information thereof, for capturing color images, in a state where there is a relatively smaller amount of light in the visible-light region or there is hardly light in the visible-light region, such as during nighttime.

Further, the amount of visible light and the amount of near-infrared light are determined from averaged values of them over the entire screen or averaged values of them over a certain area therein. Thus, if the amount of visible light is significantly larger than the amount of near-infrared light, it can be estimated that the photographing condition corresponds to daytime (there must hardly be near-infrared light, during daytime). Further, if the amount of visible light equals to the amount of near-infrared light, it can be estimated that the photographing condition corresponds to evening (the amount of near-infrared light gradually increases during evening). Further, if the amount of visible light is significantly smaller than the amount of near-infrared light, it can be estimated that the photographing condition corresponds to nighttime (there is a larger amount of near-infrared light since objects are irradiated with an near-infrared illumination, during nighttime). From these facts, it is possible to automatically change over the state of camera processing, based on the result of the estimation.

Further, in the present invention, the visible-light region refers to the wavelength range of 380 to 780 nm, and the near-infrared region refers to the wavelength range of 700 to 2500 nm.

### Effects of the Invention

With the imaging element and the imaging device according to the present invention, it is possible to acquire pixel data (luminance components and color components) about visible light and near-infrared light, which enables capturing color images in both environments having visible light such as during daytime and environments hardly having visible light such as during nighttime, thereby improving the viewability for users.

### BRIEF DESCRIPTION OF DRAWINGS

FIG. 1 is a block diagram of an imaging device according to an embodiment of the present invention.

FIG. 2 is a view illustrating the arrangement of pixels in an imaging element according to the embodiment of the present invention.

FIG. 3 is a view illustrating the pixel arrangement and the barycenter center in the imaging element according to the embodiment of the present invention.

FIG. 4 is a view illustrating an example of a filter in a signal processing portion according to the embodiment of the present invention.

FIG. 5 is a view illustrating an example of a noise reduction filter according to the embodiment of the present invention.

FIG. 6 is a view illustrating an example of motion compensation processing according to the embodiment of the present invention.

FIG. 7 is a flowchart of processing according to the embodiment of the present invention.

FIG. 8 is a view illustrating an example of extraction of color components for an unmoving object according to the embodiment of the present invention.

FIG. 9 is a view illustrating the structure of a camera in a conventional example.

FIG. 10 is a view illustrating pixel arrangement in an imaging element in a conventional example.

### BEST MODE FOR CARRYING OUT THE INVENTION

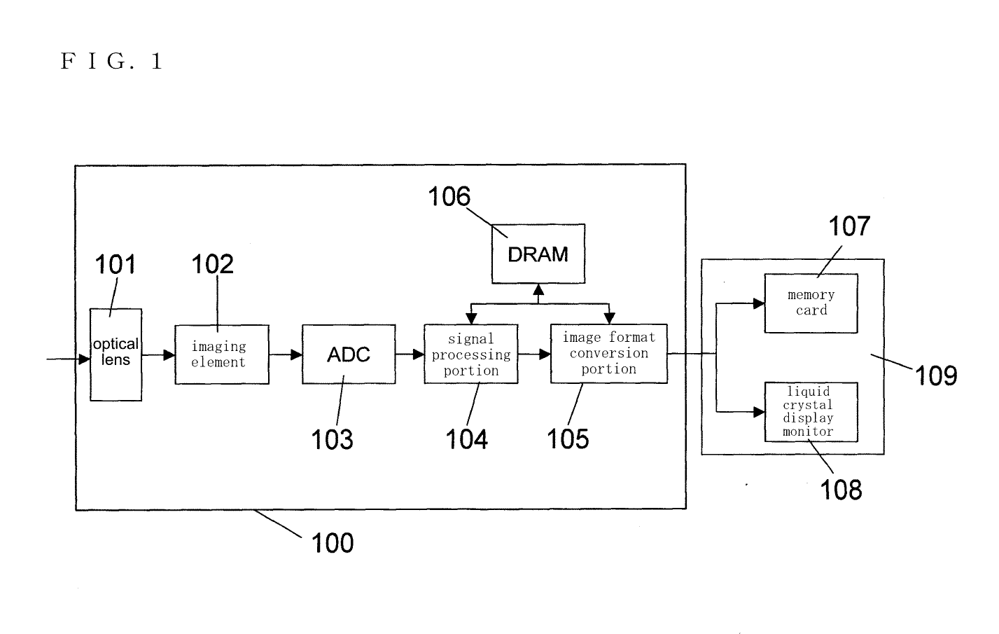

Hereinafter, there will be described, in detail, an embodiment of an imaging element and an imaging device according to the present invention, with reference to the drawings. FIG. 1 is a block diagram of an imaging device 100 according to the embodiment of the present invention.

Referring to FIG. 1, an optical lens 101 is placed in front of an imaging element (which is also referred to as an image sensor) 102, and analog data created by imaging is digitized by an ADC 103. The arrangement of pixels in the imaging element 102 will be described, later. The digitized image signals are inputted to a signal processing portion 104. The signal processing portion 104 divides the digitized image signals into luminances (or brightnesses) and color information, using an external DRAM (or a memory having the same functions) 106. The method for signal processing will be described later, in detail. An image format conversion portion 105 converts the luminance information and color information signals into signals with a format (such as JPEG or MPEG) to be outputted to an external output device 109. The output device 109 may be, for example, a liquid crystal display monitor 108 incorporated in a camera or may be a memory card 107 for recording static images.

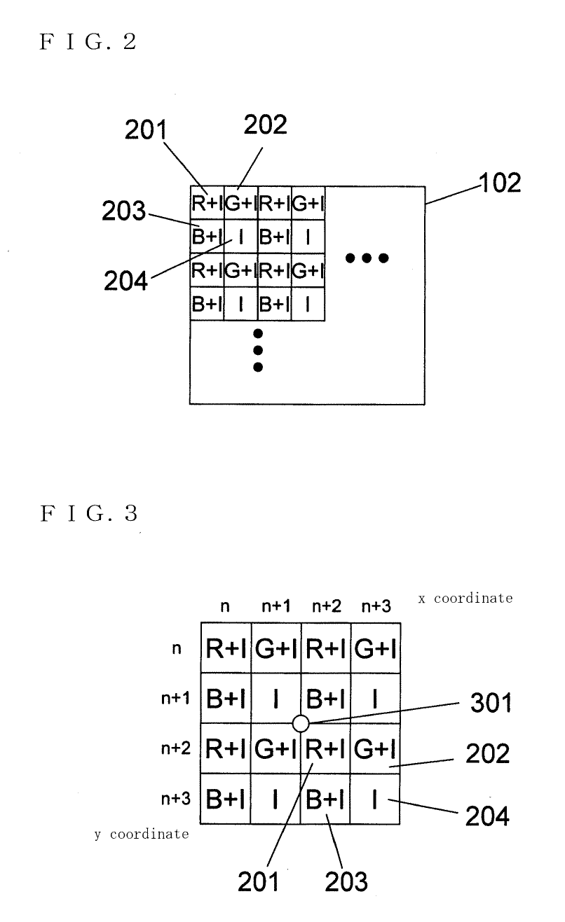

FIG. 2 illustrates an example of the arrangement of pixels in the imaging element 102 according to the embodiment of the present invention. Referring to FIG. 2, there are repeatedly placed, in a matrix shape, horizontally and vertically, R+I pixels 201 having sensitivity to wavelengths in a red region (indicated as R) and wavelengths in the near-infrared region (indicated as “I”), G+I pixels 202 having sensitivity to wavelengths in a green region (indicated as G) and wavelengths I in the near-infrared region, B+I pixels 203 having sensitivity to wavelengths in a blue region (indicated as B) and wavelengths I in the near-infrared region, and I pixels 204 having sensitivity to only wavelengths I in the near-infrared region.

The R+I pixels 201 are pixels including a filter for passing, therethrough, only red and near-infrared wavelengths, such that the filter is placed on a material sensitive to light (such as a semiconductor silicon). Also, the R+I pixels 201 can be made of a crystal material capable of passing red and near-infrared wavelengths, therethrough.

The G+I pixels 202 are pixels including a filter for passing, therethrough, only green and near-infrared wavelengths, such that the filter is placed on a material sensitive to light (such as a semiconductor silicon). Also, the G+I pixels 202 can be made of a crystal material capable of passing green and near-infrared wavelengths, therethrough.

The B+I pixels 203 are pixels including a filter for passing, therethrough, only blue and near-infrared wavelengths, such that the filter is placed on a material sensitive to light (such as a semiconductor silicon). Also, the B+I pixels 203 can be made of a crystal material capable of passing blue and near-infrared wavelengths, therethrough.

The I pixels 204 are pixels including a filter for passing, therethrough, only near-infrared wavelengths, such that the filter is placed on a material sensitive to light (such as a semiconductor silicon). Also, the I pixels 204 can be made of a crystal material capable of passing near-infrared wavelengths, therethrough.

Further, in the present embodiment, it is possible to offer the same effects, even in cases where pixels of four types as described above are interchanged, and even with an imaging element having pixels of four types placed at arbitrary positions on the imaging element. Further, although, in the imaging element, the pixels having sensitivity to the red, green and blue regions are placed, the present invention can exert similar effects even with pixels sensitive to any regions, provided that these regions are in the visible light region.

The pixels 201, 202 and 203 correspond to first pixels having sensitivity to both visible light and near-infrared light according to the present invention, while the pixels 204 correspond to second pixels selectively having sensitivity to near-infrared light according to the present invention. The imaging element 102 having the pixels 201, 202, 203 and 204 is capable of capturing color images during daytime and nighttime and, further, displaying color images during photographing at locations with less visible light than near-infrared light.

Next, there will be described a calculating method for extracting luminance components and color components at locations with a larger amount of light in the visible-light region than that of light in the near-infrared region, and at locations with a smaller amount of light in the visible-light region than that of light in the near-infrared light region. When photographing is performed at a location with a larger amount of light in the visible-light region than that of light in the near-infrared region (namely, the key light includes light in the visible-light region), the imaging element 102 captures pictures through imaging with light (first light) containing a large amount of light in the visible-light region. After performing imaging as described above, the imaging element 102 outputs imaging signals (first imaging signals) mainly containing signal components corresponding to the visible-light region. Then, the signal processing portion 104 performs signal processing (first signal processing) which is appropriate for extraction of luminance components and color components from the picture signals. On the other hand, when photographing is performed at a location with a smaller amount of light in the visible-light region than that of light in the near-infrared region (namely, the key light includes light in the near-infrared light range), the imaging element 102 captures pictures through imaging with light (second light) containing a larger amount of light in the near-infrared light region. After performing imaging as described above, the imaging element 102 outputs imaging signals (second imaging signals) mainly containing signal components corresponding to the near-infrared light region. Then, the signal processing portion 104 performs signal processing (second signal processing) which is appropriate for extraction of luminance components and color components from the picture signals. The signal processing portion 104 performs these first and second signal processing, by properly changing over therebetween.

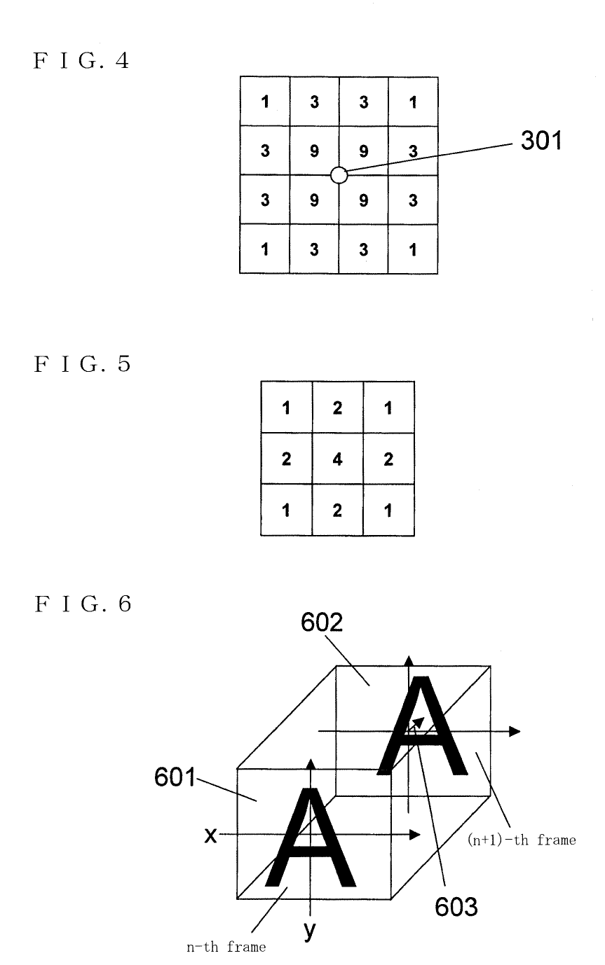

FIG. 3 illustrates the pixel arrangement and the barycenter position which are used in the signal processing, and FIG. 4 illustrates an example of filter factors for use in the signal processing. At first, the values (R+I)′, (G+I)′, (B+I)′ and (I)′ of the R+I pixels 201, the G+I pixels 202 and the B+I pixels 203 and the I pixels 204 at the barycenter position 301 can be calculated by performing interpolation processing with the filter factors illustrated in FIG. 4.

The formulas for the calculations are formulas (1), (2), (3) and (4) as follows.

(R+I)′=[9*(R+I)_{(n+2, n+2)}3*(R+I)_{(n+2, n)}+3 (R+1)_{(n, n+2)}+(R+I)_{(n, n)}]/16 (1)

(G+I)′=[9*(G+I)_{(n+1, n+2)}+3*(G+I)_{(n+1, n)}+3(G+1)_{(n+3, n+2})+(G+I)_{(n+3, n)}]/16 (2)

(B+I)′=[9*(B+I)_{(n+2, n+1)}+3*(B+I)_{(n, n+1)}+3(B+1)_{(n+2, n+3)}+(B+I)_{(n, n+3)}]/16 (3)

(I)′=[9*(I)_{(n+1, n+1)}+3*(I)_{(n+3, n+1)}+3*(I)_{(n+1, n+)}+(I)_{(n+3, n+3)}]/16 (4)

Here, (R+1), (G+I) and (B+I) indicate the first signal components outputted by the first pixels (the R+I pixels 201, the G+I pixels 202 and the B+I pixels 203), (I) indicates the second signal component outputted by the second pixels (the I pixels 204), and (n, n) indicates the coordinate position at x=n and y=n.

Based on the aforementioned formulas (1), (2), (3) and (4), it is possible to calculate the luminance component (Y component) and the color components (R, B and G components) at the barycenter position 301 during daytime, using the following formulas (Y-1), (R-1), (G-1) and (B-1). These calculation formulas substantially correspond to the first signal processing.

Y=0.299(R+I)′+0.587(G+I)′+0.114(B+I)′−I′ (Y-1)

R′=(R+I)′−I′ (R-1)

G′=(G+I)′−I′ (G-1)

B′=(B+I)′−I′ (B-1)

The formula (Y-1) is a formula for calculating luminance (Y) using R, G and B. In the formula (Y-1), the near-infrared light component I is subtracted from the basic formula of Y=0.299(R+I)′+0.587(G+I)′+0.114(B+I)′, thereby determining, through calculation, pure R, G and B components with no noise components, in focusing an attention on a fact that extra near-infrared light component I is mixed in R, G and B. Similarly, in the formulas (R-1), (G-1) and (B-1), the extra near-infrared light component I is subtracted. Further, “I′” indicates the value of near-infrared light component at each pixel position (the position of each of the R+I pixels 201, the G+I pixels 202 and the B+I pixels 203). In this case, the value of the near-infrared light component at each pixel position is unknown, and, therefore, I′ can be calculated by performing interpolation using the I pixels 204 therearound. Further, the calculation formula for extracting luminance components from picture signals based on visible light corresponds to the formula (Y-1), and the calculation formulas for extracting color components from picture signals based on visible light correspond to the formulas (R-1), (G-1) and (B-1).

Luminance components (Y components) and color components (R, G and B components) during nighttime can be extracted using the following formulas (Y-2), (R-2), (G-2) and (B-2). These calculation formulas substantially correspond to the second signal processing.

Y=0.25(R+I)′+0.25(G+I)′+0.25(B+I)′+0.25I′ (Y-2)

R′=(R+I)′−I′ (R-2)

G′=(G+I)′−I′ (G-2)

B′=(B+I)′−I′ (B-2)

During nighttime, there are significantly smaller R, G and B components and, therefore, even if luminance (Y) is extracted in the same was as that for daytime, the luminance (Y) can not serve as luminance information. In order to create signals with highest possible levels, in the formula (Y-2), the value of each pixel is multiplied by a factor of 0.25 such that the values of the four types of pixels 201 to 204 are evenly increased. Further, while the formula (Y-2) is made for evenly increasing the values of the four types of pixels for calculating the luminance (Y), it is also possible to arbitrarily set the respective factors in such a way as to enhance the general versatility. Further, the setting of these factors are preliminarily performed through a host.

Further, the calculation formula for extracting luminance components from picture signals based on visible light and near-infrared light corresponds to the formula (Y-2), and the calculation formulas for extracting color components from picture signals based on visible light and near-infrared light correspond to the formulas (R-2), (G-2) and (B-2).

The aforementioned calculations for extracting luminance components and color components are performed through hardware operations (or software operations) by the signal processing portion 104. Between the calculation for extraction at locations with a larger amount of light in the visible-light region (the first signal processing) and the calculation for extraction at locations with a smaller amount of light in the visible-light region (with a larger amount of light in the near-infrared light region) (the second signal processing), changing over is performed as follows. Namely, a comparison is made between the signal levels of first signal components and the signal levels of second signal components and, if the signal levels of first signal components are higher than the signal levels of second signal components and, also, the difference therebetween is equal to or more than a pre-set first threshold value, it is determined that light received by the imaging element 102 is first light, and the first signal processing is performed. On the other hand, if the signal levels of first signal components are higher than the signal levels of second signal components but the difference therebetween is less than the first threshold value, or if the signal levels of first signal components are equal to the signal levels of second signal components, it is determined that light received by the imaging element 102 is second light as described above, and, thus, the second signal processing is performed.

The aforementioned determination is made as follows. That is, after integrated values of visible-light/near-infrared-light (integrated values of first and second signal components) are monitored, hardware or a microcomputer makes the determination based on the result of the monitoring and, then, supplies the result of the determination to the signal processing portion 104. The signal processing portion 104 performs changing over between the calculations for extraction, based on commands for changeover supplied thereto. Further, the signal processing portion 104 can be regarded as being substantially constituted by the micro computer and, therefore, the determination for changing over can be regarded as being performed by the signal processing portion 104. Further, in cases of in-vehicle cameras and the like, changing over between the calculations for extraction can be performed, based on commands supplied from the vehicle main bodies. Such commands to be supplied from the vehicle main bodies can be created based on ON/OFF operations on the head light switches in the vehicles, for example. Namely, when the headlight switch is off, it is possible to determine that it is daytime and to perform a changeover to the calculation for extraction for locations with a larger amount of visible light. On the other hand, when the headlight switch is on, it is possible to determine that it is nighttime and to perform a changeover to the calculation for extraction for locations with a smaller amount of visible light.

In this case, when there are less visible light components, such as during nighttime, the R′, G′ and B′ components are significantly smaller, which makes it impossible to accurately extract the color components. Therefore, by performing noise reduction processing, in the second signal processing, it is possible to accurately extract color components. Such noise reduction processing will be described, subsequently.

On picture signals outputted from the visible-light pixels, noise reduction processing is performed, within frames thereof, using a noise reduction filter with filter factors illustrated in FIG. 5 and with a size of 3TAP in the horizontal and vertical directions. Thereafter, color components are extracted from the picture signals having been subjected to the noise reduction processing. This noise reduction processing is performed by the signal processing portion 104 and, more specifically, a convolution operation (convolution) is performed. Namely, referring to FIG. 5, on the assumption that I1, 12 and 13 are pixel values in the rightward direction from the upper-left pixel position (with a weight of 1), further I4, I5 and I6 are pixel values in the second stage, similarly, and I7, I8 and I9 are pixel values similarly in the lowest stage, the pixel value (the picture signal) at the position I5 after the noise reduction can be calculated according to the following formula (5).

(I1*1+I2*2+I3*1+I4*2+I5*4+I6*2+I7*1+I8*2+I9*1)/16 (5)

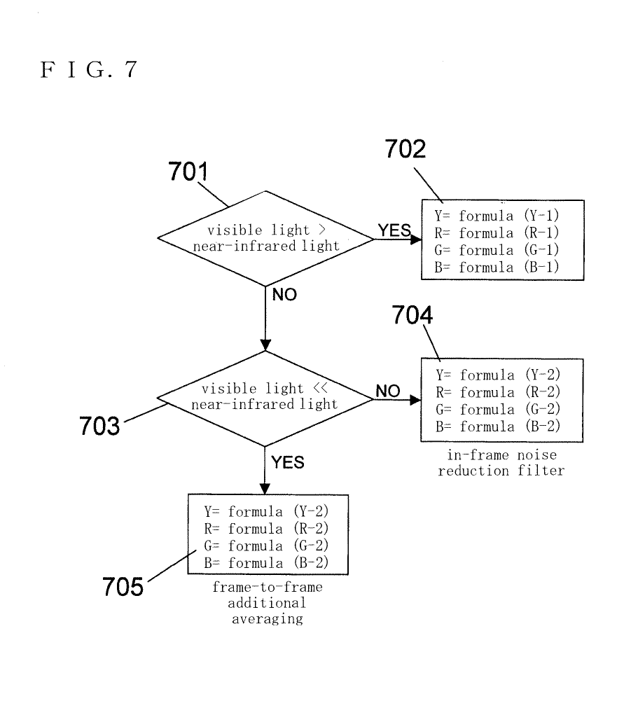

Further, when the R′, G′ and B′ components are smaller, it is difficult to attain sufficient noise reduction, even by performing, thereon, the noise reduction processing using the noise reduction filter. In such cases, frame-to-frame additional averaging processing is performed for attaining noise reduction. In this case, if additional averaging is performed directly in the event of a motion between frames, it is impossible to attain accurate addition, thereby causing color bleeding and the like. To cope therewith, a threshold value (Δx, Δy) is set, in advance, for motions between an arbitrary pixel (x, y)₆₀₂ in the (n+1)-th frame 602 and the pixel (x, y)₆₀₁ in the n-th frame 601, then a comparison is made between the motion threshold value (Δx, Δy) and the amount (Δxi, Δyi) of change in motion between the pixel (x, y)₆₀₂ in the (n+1)-th frame 602 and the pixel (x, y)₆₀₁ in the n-th frame 601. Further, if there has occurred a motion 603 with an amount (Δxi, Δyi) of motion change which is equal to or more than the motion threshold value (Δx, Δy), the amounts of motions at respective portions in the n-th frame 601 and the amounts of motions at the respective portions in the (n+1)-th frame 602 are calculated through frame-to-frame differentiation processing and the like as illustrated in FIG. 6 and, then, additional averaging is performed over the pixel (x, y)₆₀₂ in the (n+1)-th frame 602 and the pixel (x-Δx y-Δy)₆₀₁ in the n-th frame 601. This enables canceling the amount of motion. Therefore, it is possible to accurately perform additional averaging, even in the event of a motion. In this case, the motion threshold value (Δx, Δy) corresponds to a predetermined amount as a reference value for amounts of motion changes.

The noise reduction processing using the frame-to-frame additional averaging processing is performed by the signal processing portion 104. Further, in the present invention, it is also possible to perform single noise reduction processing using only one of a noise reduction filer and frame-to-frame additional averaging processing, as well as performing noise reducing processing through both noise reduction processing using a noise reduction filter and noise reduction processing using frame-to-frame additional averaging processing.

Out of the processing for extracting luminance components and color components and, then, performing noise reduction processing using a noise reduction filter on the extracted color components (which will be referred to as second-1 signal processing), and the processing for performing processing for extracting luminance components and color components and, then, performing noise reduction processing using frame-to-frame additional averaging processing on the extracted color components (which will be referred to as second-2 signal processing), the determination as to which of these processing should be performed is made, by comparing the difference between the signal levels of the R+1 pixels 201, the G+1 pixels 202 and the B+1 pixels 203 (the signal levels of the first signal components) and the signal levels of the I pixels 204 (the signal levels of the second signal components) with a predetermined threshold value. Namely, when the difference is sufficiently larger, the noise reduction processing using the noise reduction filter is performed. When the difference is not sufficiently larger, the noise reduction processing using the frame-to-frame additional averaging processing is performed. Also, the determination as to which of these processing should be performed can be made, based on commands from the host-side (such as the vehicle-side).

More specifically, when the signal levels of the first signal components are larger than the signal levels of the second signal components and, also, the difference therebetween is equal to or more than a second threshold value but less than the aforementioned first threshold value (the first threshold value>the second threshold value), the signal processing portion 104 determines that the difference is significantly larger and performs the second-1 signal processing. On the other hand, when the signal levels of the first signal components are larger than the signal levels of the second signal components but the difference therebetween is less than the second threshold value or when the signal levels of the first signal components are equal to the signal levels of the second signal components, the signal processing portion 104 determines that the difference is not significantly larger and performs the second-2 signal processing.

Detections of motions between frames are performed as follows. Namely, a differential image between the previous frame 601 and a current frame 602 is created or pattern matching is performed between both the frames, then, based on the result thereof (the differential image or the result of pattern matching), calculations are performed for determining how much objects moved between both the frames, and then the motion between the frames is detected from the calculated amount of motion.

Further, as described above, changing over is performed between the noise reduction processing using additional averaging processing and the noise reduction processing using frame-to-frame additional averaging processing, based on the result of the comparison between the amplitudes of the signal levels of the first signal components and the first and second threshold values. The changeover between these noise reduction processing is performed by the signal processing portion 104.

Also, instead of performing simple additional averaging, the addition ratio between respective frames can be changed, which enables additional averaging with higher accuracy. Namely, in performing additional averaging over a current frame and averaged images, it is possible to assign weights to them for changing the degree of followability (the time constant) for motions. For example, when a larger weight is assigned to the averaged images, if a motion occurs, the sensitivity to the motion is lower (the motion can not be reflected immediately). This processing is performed by the signal processing portion 104.

Further, when there has occurred a larger motion between frames, processing for restarting addition is performed, again, without performing addition. This enables additional averaging processing with higher accuracy. The determination as to whether or not the amount of motion (Δxi, Δyi) between frames is larger is made, based on whether or not the amount of motion (Δxi, Δyi) is larger than a predetermined motion threshold value (Δx, Δy). Further, the determination as to whether or not additional averaging should be restarted is made, by making a comparison between the amount of motion (Δxi, Δyi) and the motion threshold value (Δx, Δy). Namely, if the amount of motion (Δxi, Δyi) is less than the motion threshold value (Δx, Δy), additional averaging is restarted. This processing is performed by the signal processing portion 104.

Further, when color components can not be accurately obtained, the following processing is performed. Namely, noise reduction processing using a noise reduction filter is performed, further bit-down is performed, and approximate values of color information are calculated. Thereafter, the color components are changed according to luminance information. This enables creating color components with no noises. In this case, “states where color components can not be obtained accurately” refers to states as follows. Namely, in a state where the signal levels of the R+I pixels 201, the G+I pixels 202 and the B+I pixels 203 corresponding to the visible-light region are significantly smaller, there are significantly smaller S/N levels, which makes it impossible to accurately obtain color components. Such states are referred to as states where color components can not be accurately obtained. Further, the determination as to whether or not they are significantly smaller is made, by making a comparison between the signal levels in the visible light region and a predetermined threshold value (more specifically, by making a comparison between the signal levels of the first signal components and the second threshold value). Further, the noise reduction filter can be the same as that in FIG. 5, but is not be particularly limited to the noise reduction filter illustrated in FIG. 5. Further, since division is performed through the bit-down, it is possible to reduce noises, although this degrades the data accuracy. Further, “color components are changed according to luminance information” means that color information values in images are thinned (for example, a single pixel is subtracted out of each eight pixels) and, then, color components are calculated for the other pixels according to the ratio between magnitudes of luminance levels. There will be assumed a case where, based on a pixel A having color information, color information about an adjacent pixel A-1 is calculated. In this case, the luminance ratio between the luminance value of the pixel A and the luminance value of the adjacent pixel A-1 is calculated and, then, color information about the adjacent pixel A-1 is calculated by multiplying the color component of the pixel A by the luminance ratio. This processing is performed by the signal processing portion 104.

Next, with reference to a flowchart of FIG. 7, there will be described an automatic control method for changing over between the noise reduction processing using the noise reduction filter and the noise reduction processing using the frame-to-frame additional averaging processing.

In order to detect the photographing condition, in advance, the signal processing portion 104 makes a comparison between an average value of signal levels of signal components outputted from the visible-light pixels (R, G and B) in the screen, and an average value of signal levels of signal components outputted from the near-infrared-light pixels (I) (Determination 701). In this case, in the present invention, there is no visible-light pixels (R, G, B), but there exist the pixels (R+I), the pixels (G+I) and the pixels (B+I), instead thereof. Therefore, a comparison is made between an average value of first signals outputted from the pixels (R+I), the pixels (G+I) and the pixels (B+I) and an average value of second signal components outputted from the pixels (I).

If, as a result of the Determination 701, the signal levels of signal components outputted from the visible-light pixels (R, G, B) are larger than the signal levels of second signal components, more specifically if the signal levels of first signal components are larger than the signal levels of second signal components and, also, the difference therebetween is larger than the pre-set first threshold value, it is determined that the photographing condition corresponds to daytime, and light received by the imaging element 102 is first light and, thus, the first signal processing is performed. Namely, luminance and color components are extracted, from the first signal components, based on the formulas (Y-1), (R-1), (G-1) and (B-1) (Processing 702).

Next, if the second signal components (the near-infrared light pixel values) are larger than the first signal components (the visible-light pixel values) (NO in the Determination 701), but there slightly remain first pixel components (the visible-light pixel values) (YES in determination 703), more specifically, if the signal levels of the first signal components are larger than the signal levels of the second signal components but the difference therebetween is equal to or more than the second threshold value but is less than the first threshold value (the first threshold value>the second threshold value), it is determined that the photographing condition does not correspond to daytime, and light received by the imaging element 102 is second light, but the photographing is not performed during nighttime (photographing is performed during evening and the like) since the difference is significantly larger and, thus, the second-1 signal processing is performed. Namely, a luminance component is calculated from the first signal components based on the formula (Y-2) and, also, color components are calculated from the first signal components based on the formulas (R-2), (G-2) and (B-2) and, thereafter, the calculated color components are subjected to noise reduction processing using the noise reduction filter, within the frames. Thus, it is possible to create color components with less noise (Processing 704).

Next, if the near-infrared light is sufficiently larger than the visible light, and visible components are significantly smaller (YES in determination 703), more specifically, if the signal levels of the first signal components are larger than the signal levels of the second signal components but the difference therebetween is less than the second threshold value, or the signal levels of the first signal components are equal to the signal levels of the second signal components, it is determined that the photographing condition does not correspond to daytime, and light received by the imaging element 102 is second light and, also, photographing is performed during nighttime since the difference is not significantly larger and, thus, the second-2 signal processing is performed. Namely, a luminance component is calculated from the first signal components based on the formula (Y-2) and, also, color components are calculated from the first signal components based on the formulas (R-2), (G-2) and (B-2) and, thereafter, the calculated color components are subjected to the noise reduction processing using the frame-to-frame additional averaging processing. Thus, it is possible to create color components with less noise (Processing 705).

Further, when the first signal components and the second signal components are calculated, it is possible to calculate them to have values averaged over the entire screen and, also, it is possible to calculate them to have values averaged over only a certain area in the screen. Regarding the specification of the entire screen or a certain area in the screen, an area to be subjected to integration is preliminarily specified, by making the setting thereof from the host-side through a resister or the like. Further, as such a certain area, it is possible to specify an area regarded as being important for photographing conditions, such as the center of the screen. Further, this processing is conducted by the signal processing portion 104.

Further, instead of changing over among the processing 702, 704 and 705, it is also possible to perform the respective processing such that they include weighting averaging processing according to first signal components and second signal components, which enables preventing abrupt image changes. Namely, when signal components are around the first and second threshold values, if they suddenly change, this may make it impossible to stabilize captured images depending on the severity of noises, thereby inducing repeated abrupt changes. Therefore, based on the necessity of assigning a time constant to each change, the calculations in the respective processing are performed, after weighting averaging processing is performed according to the first signal components and the second signal components. This processing is performed by the signal processing portion 104.

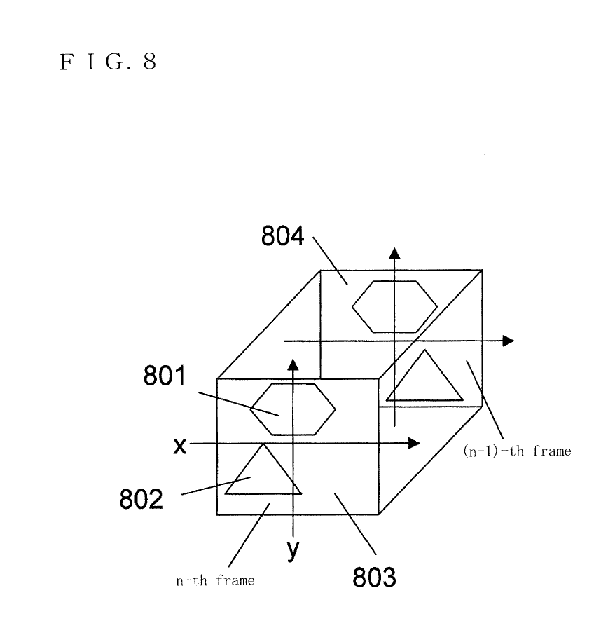

Next, there will be described processing for photographing under conditions where there are less motions, such as in cases of fixed cameras. As illustrated in FIG. 8, for an area 802 within which a motion has occurred between an n-th frame 803 and an (n+1)-th frame 804, color components extracted through noise reduction processing (single-frame noise reduction processing or frame-to-frame noise reduction processing) are employed. For an area 801 within which no motion has occurred, color information is extracted under a condition where there is sufficient visible light, such as during daytime and, then, is preliminarily accumulated in a memory or the like, and the accumulated color information is used for creating color components during photographing under conditions where there is less visible light, such as during nighttime. Thus, it is possible to create accurate color components for unmoving objects. Further, this processing is performed by the signal processing portion 104.

### INDUSTRIAL APPLICABILITY

The imaging device according to the present invention is usable for creating color pictures and improving the viewability with an imaging device which is required to perform photographing during both daytime and nighttime, such as an in-vehicle camera or a monitoring camera, particularly.

### DESCRIPTION OF REFERENCE CHARACTERS

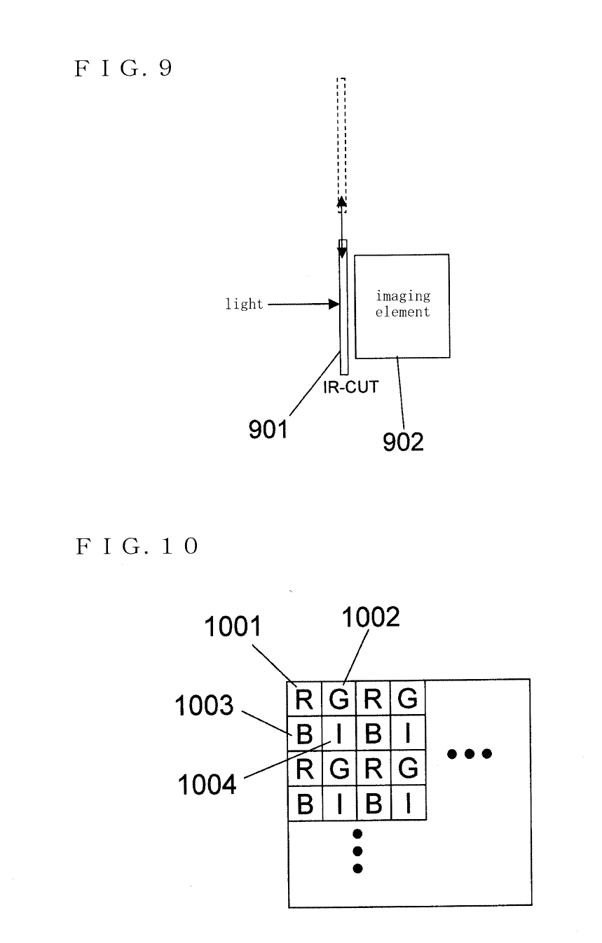

100 Imaging device
101 Optical lens
102 Imaging element (image sensor)
103 ADC
104 Signal processing portion
105 Image format conversion portion
106 DRAM
107 Memory card
108 Liquid crystal display monitor
109 Output device
109 Output device
201 R+1 pixel
202 G+1 pixel
203 B+1 pixel
204 I pixel
FIG. 1
101) Optical lens
102) Imaging element
104) Signal processing portion
105) Image format conversion portion
107) Memory card
108) Liquid crystal display monitor
FIG. 3
1) x coordinate
2) y coordinate
FIG. 6
1) n-th frame
2) (n+1)-th frame
FIG. 7
701) Visible light>Near-infrared light
702) Y=formula (Y-1)
   R=formula (R-1)
   G=formula (G-1)
   B=formula (B-1)
1) In-frame noise reduction filter
2) Frame-to-frame additional averaging
FIG. 9
1) Light
902) Imaging element

1. An imaging device comprising:
an imaging element; and
a signal processing portion adapted to extract a luminance component and a color component from a picture signal outputted from the imaging element, in response to reception light; wherein
the picture signal is changed to a first picture signal mainly containing a signal component corresponding to a visible-light region, and a second picture signal mainly containing a signal component corresponding to a near-infrared region, according to the state of the reception light, and
the signal processing portion is adapted to perform first signal processing appropriate for extracting the luminance component and the color component from the first picture signal, and second signal processing appropriate for extracting the luminance component and the color component from the second picture signal, by changing over therebetween.

2. The imaging device according to claim 1, wherein
the imaging element receiving first light containing a sufficient amount of light in the visible-light region is adapted to output the first picture signal, and
the imaging element receiving second light which does not contain a sufficient amount of light in the visible-light region is adapted to output the second picture signal.

3. The imaging device according to claim 2, wherein
the first light contains key light including light in the visible light region and in the near-infrared region, and
the second light contains key light including light in the near-infrared region.

4. The imaging device according to claim 1, wherein
the signal processing portion is adapted to change over between the first signal processing and the second signal processing, based on determination of the signal state of the picture signal.

5. The imaging device according to claim 2, wherein
the imaging element includes a first pixel having sensitivity to both the visible-light region and the near-infrared region, and a second pixel selectively having sensitivity to the near-infrared region,
the picture signal contains a first signal component outputted from the first pixel and a second signal component outputted from the second pixel,
the signal processing portion is adapted to determine that the reception light is the first light and to perform the first signal processing, when the signal level of the first signal component is larger than the signal level of the second signal component and, also, the difference therebetween is equal to or more than a first threshold value, and
the signal processing portion is adapted to determine that the reception light is the second light and to perform the second signal processing, when the signal level of the first signal component is larger than the signal level of the second signal component but the difference therebetween is less than the first threshold value, or when the signal level of the first signal component is equal to the signal level of the second signal component.

6. The imaging device according to claim 5, wherein
the signal processing portion is adapted to perform noise reduction processing using an in-frame noise reduction filter on the extracted color component, in the second signal processing.

7. The imaging device according to claim 5, wherein
the signal processing portion is adapted to perform noise reduction processing through frame-to-frame additional averaging processing on the extracted color component, in the second signal processing.

8. The imaging device according to claim 7, wherein
the signal processing portion is adapted to perform noise reduction processing through the frame-to-frame additional averaging processing on the extracted color component, in the second signal processing.

9. The imaging device according to claim 8, wherein
when there is an amount of motion change between frames which is larger than a predetermined amount in the first signal component, the signal processing portion is adapted to perform noise reduction processing through the frame-to-frame additional averaging processing on the color component, without performing correction of the motion between the frames.

10. The imaging device according to claim 2, wherein
the signal processing portion is adapted to extract, in the second signal processing, the color component from the first signal component, according to the luminance component extracted through the second signal processing, when the color component can not be accurately extracted from the first signal component.

11. The imaging device according to claim 5, wherein
the second signal processing includes
second-1 signal processing for extracting the luminance component and the color component from the first signal component and for performing noise reduction processing using an in-frame noise reduction filter on the extracted color component, and
second-2 signal processing for extracting the luminance component and the color component from the first signal component and for performing noise reduction processing through frame-to-frame additional averaging processing on the extracted color component, and
the signal processing portion is adapted to perform the first signal processing, the second-1 signal processing and the second-2 signal processing, by changing over thereamong.

12. The imaging device according to claim 11, wherein
the signal processing portion is adapted to perform the second-1 signal processing, when the signal level of the first signal component is larger than the signal level of the second signal component and, also, the difference therebetween is equal to or more than a second threshold value but is less than the first threshold value (the first threshold value>the second threshold value), and
the signal processing portion is adapted to perform the second-2 signal processing, when the signal level of the first signal component is larger than the signal level of the second signal component but the difference therebetween is less than the second threshold value, or when the signal level of the first signal component is equal to the signal level of the second signal component.

13. The imaging device according to claim 5, wherein
the signal processing portion is adapted to determine the signal levels of the first and second signal components, based on average values of the signal levels of the first and second signal components over the entire screen or average values of the signal levels of the first and second signal components over an arbitrary area within the screen.

14. The imaging device according to claim 5, further comprising a storage device for storing the color component, wherein
the signal processing portion is adapted to store, in the storage device, the color component extracted through the first signal processing, and
the signal processing portion is adapted to extract the luminance component from the first signal component and, also, is adapted to read the color component stored in the storage device and use the read color component as a color component for an area within which no motion has occurred within frames in the first picture signal and to extract the color component from the first signal component having been subjected to noise reduction processing, for an area within which a motion has occurred within frames, in the second signal processing.

15. An imaging element comprising a plurality of pixels, wherein
the plurality of pixels include a first pixel having sensitivity to both a visible-light region and a near-infrared region, and a second pixel having sensitivity to a near-infrared region.
